(19) United States
(12) Patent Application Publication
(10) Pub. No.: US 2005/0258024 A1
(43) Pub. Date: Nov. 24, 2005

(54) Switchgear assembly for distribution of electrical power

(76) Inventor: Lutz Niemeyer, Birr (CH)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/401,864

(22) Filed: Mar. 31, 2003

(30) Foreign Application Priority Data
Apr. 12, 2002 (EP) 02405292.0

(51) Int. Cl. H01H 15/00

(52) U.S. Cl. 200/545

(57) ABSTRACT

The basic unit (1) of a switchgear assembly has a ring busbar (2), four outgoers (7, 8, 9, 10) which are connected to the busbar (2) via a respective isolator (3, 4, 5, 6), as well as two commutation switching elements (11, 12) and two disconnection elements (13, 14), which are arranged in the busbar (2) and are closed during normal operation. Each outgoer (7, 8, 9, 10) is connected via a commutation switching element (11, 12) to one of the adjacent outgoers, and via a disconnection element (13, 14) to the other of the adjacent outgoers. The basic unit (1) also has a third commutation switching element (15), which is closed during normal operation and is connected in series both with the first commutation switching element (11) and with the second commutation switching element (12). Each disconnection element (13, 14) is thus bridged by a parallel current path comprising two commutation switching elements (11, 15; 12, 15) which are in each case connected in series. The commutation switching elements (11, 12, 15) are designed for carrying the rated current and, briefly, a fault current, but are not designed for disconnection of fault currents. In contrast, the disconnection elements (13, 14) are designed for fault current interruption, but not for carrying the rated current.

### FIELD OF THE INVENTION

The invention relates to a switchgear assembly for distribution of electrical power, as claimed in the precharacterizing clause of claim 1, and to a method for operation of this switchgear assembly.

### BACKGROUND OF THE INVENTION

In conventional switchgear assemblies having a ring busbar and having a number of outgoers, circuit breakers which are closed during normal operation are arranged in the busbar, between each two adjacent outgoers. Each of these circuit breakers is designed not only for current interruption but also for carrying the rated current, which makes it necessary for the contact system to have a correspondingly complex configuration. The circuit breakers (one for each outgoer) are, however, operated very rarely, and generally only in the event of a fault, but make up a high proportion of the costs of the overall switchgear assembly.

### SUMMARY OF THE INVENTION

The present invention is based on the object of providing a switchgear assembly of the type mentioned initially, which does not require such expensive components as conventional switchgear assemblies with a ring busbar.

According to the invention, this object is achieved by a switchgear assembly having the features of claim 1.

In the switchgear assembly according to the invention, the commutation switching elements carry the rated current. The disconnection elements which are used for interruption of fault currents therefore do not have to carry the rated current. This makes it possible to use a device whose cost is less than that of a circuit breaker as the disconnection element. Apart from being designed to carry the rated current, the commutation switching elements need be designed to carry fault currents only briefly, but not to disconnect them. The contact system of a commutation switching element may therefore be designed to be physically simpler than that of a circuit breaker. This all assists the process of reducing the switchgear assembly costs.

The switchgear assembly according to the invention is operated using the method as claimed in claim 9.

Preferred further refinements of the subject matter of the invention are described in the dependent claims.

### BRIEF DESCRIPTION OF THE DRAWINGS

The invention will be explained in more detail in the following text with reference to figures, which represent only exemplary embodiments, and in which:

FIG. 1 shows the basic unit of a first embodiment of a switchgear assembly,

FIG. 2 shows a first upgraded variant of the switchgear assembly as shown in FIG. 1,

FIG. 3 shows a second upgraded variant of the switchgear assembly as shown in FIG. 1,

FIG. 4 shows the basic unit of a second embodiment of a switchgear assembly, and

FIG. 5 shows an upgraded variant of the switchgear assembly shown in FIG. 4.

### DETAILED DESCRIPTION OF THE INVENTION

The physical configuration of the disconnection elements and of the commutation switching elements, which form parts of the switchgear assemblies according to the invention as illustrated in the figures, will be described first of all.

A disconnection element is designed for current interruption, but not for carrying the rated current, and has a switching contact system via which only a small current flows during normal operation. This switching contact system may correspond to the power switching contact system of a conventional circuit breaker. However, a quick-action switch, a current limiting device, a semiconductor switching apparatus, a superconductor with a series-connected load disconnector, a fuse or a reconnectable fuse element may also be used as the disconnection element.

A commutation switching element is designed for carrying the rated current and, briefly, a fault current, but not for interruption of this fault current, and is constructed such that, when it opens, the current commutates onto a current path in which a disconnection element is connected. The design of the commutation switching elements, whose contact system is designed in a similar manner to the rated current contact system in a conventional circuit breaker, ensures that, on opening, a sufficiently high arc voltage is formed for the current to commutate onto the other current path, as mentioned above, within the necessary switching time. One example of a suitable design configuration of the contact system of such a commutation switching element is disclosed in U.S. Pat. No. 4,371,765.

FIG. 1 shows the basic unit 1 of a first embodiment of a switchgear assembly according to the invention, which has a ring busbar 2, four outgoers 7, 8, 9, 1 0 which are connected via a respective isolator 3, 4, 5 and 6 to the busbar 2, as well as two commutation switching elements 11, 12 and two disconnection elements 13, 14, which are arranged in the busbar 2 and are closed during normal operation. The commutation switching element 11 connects the outgoers 7 and 8, which are themselves connected to the outgoers 10 and 9, respectively, via the respective disconnection elements 13 and 14. The commutation switching element 12 connects the outgoers 9 and 10 to one another. Each outgoer 7, 8, 9, 10 is thus connected via a commutation switching element 11 or 12 to one of the adjacent outgoers, and via a disconnection element 13 or 14 to the other of the adjacent outgoers. The basic unit 1 also has a third commutation switching element 15, which is closed during normal operation and is connected in series both with the first commutation switching element 11 and with the second commutation switching element 12. The disconnection element 13 is thus bridged by a first parallel current path comprising the commutation switching elements 11 and 15 connected in series, and the disconnection element 14 is bridged by a second parallel current path comprising the commutation switching elements 12 and 15 connected in series.

The dashed lines in FIG. 1 show a circuit breaker 16, which is no longer part of the basic unit 1, is arranged at the other end of the outgoer 7, and forms part of another switchgear assembly.

During normal operation, when all the commutation switching elements 11, 12, 15 and both disconnection elements 13, 14 are closed, the commutation switching elements 11, 12, 15 carry the current and ensure that there is a connection between all the outgoers 7, 8, 9, 10.

If a fault occurs, by way of example, on the outgoer 8, then the adjacent commutation switching elements 11 and 15 open first of all. The fault current is now commutated onto another current path, in which the disconnection elements 14 are located. The fault current which flows in this current path is interrupted by the disconnection element 14. The outgoers 7, 9 and 10 are still connected to one another. If a further fault were also to occur at the same time in one of the other outgoers 7, 9, 10, for example in the outgoer 7, then the disconnection element 13 and the circuit breaker 16 at the other end of the outgoer 7 would interrupt the fault current.

In the event of a fault in one of the other outgoers 7, 9 or 10, the fault current would be disconnected in a corresponding manner.

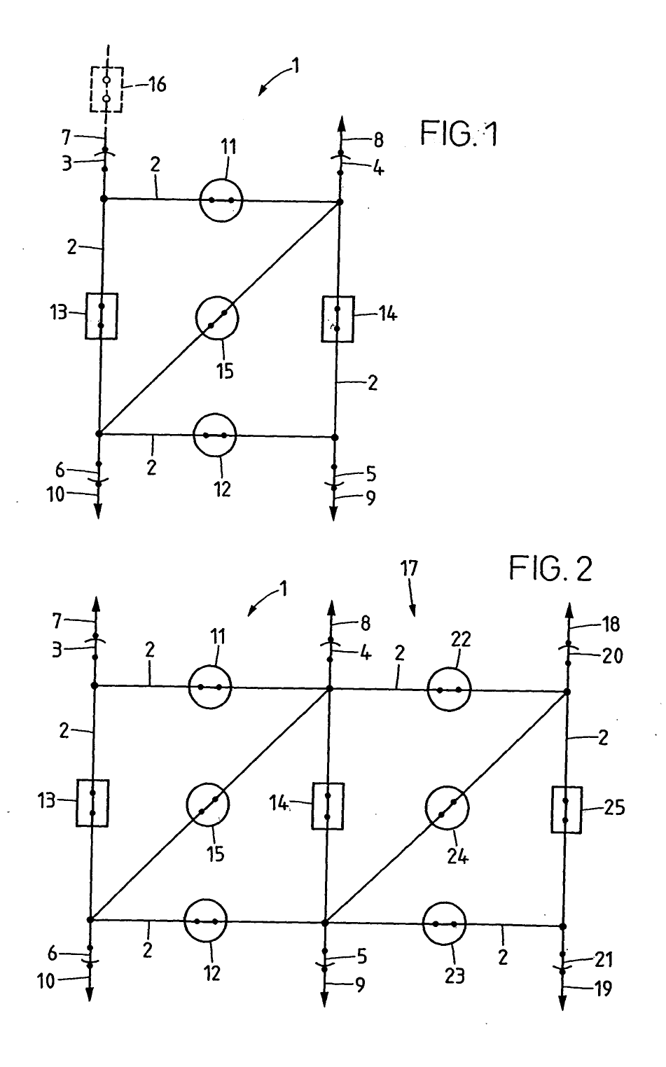

FIG. 2 shows a first upgraded variant of the switchgear assembly as shown in FIG. 1, in which an assembly block 17 is added to the basic unit 1 as shown in FIG. 1. The same reference symbols are used for the components of the basic unit 1 in FIGS. 1 and 2.

The assembly block 17 has two outgoers 18 and 19, which are connected via a respective isolator 20 or 21 to the ring busbar 2. The assembly block 17 also has three commutation switching elements 22, 23, 24 and a disconnection element 25. The commutation switching elements 22 and 23 are arranged in the busbar 2 and connect a respective one of the outgoers 18 or 19 of the assembly block 17 to the respectively adjacent outgoer 8 or 9 of the basic unit 1. The disconnection element 25, which is likewise arranged in the busbar 2, connects the two outgoers 18 and 19 of the assembly block 17. The third commutation switching element 24 of the assembly block 17 is connected in series both with the commutation switching element 22 and with the commutation switching element 23. The two series-connected commutation switching elements 23 and 24 form a parallel current path, which bridges the disconnection element 25.

During normal operation, all the commutation switching elements 11, 12, 15, 22, 23, 24 and all the disconnection elements 13, 14, 25 in the basic unit 1 and in the assembly block 17 are closed. The commutation switching elements 11, 12, 15, 22, 23 and 24 thus carry the current and ensure that all the outgoers 7, 8, 9, 10, 18, 19 are connected.

If a fault occurs in one of the outgoers 7, 10, 18 or 19, then, as described with reference to FIG. 1, the corresponding adjacent commutation switching elements 11, 12, 15, 22, 23 and 24 are opened in order to ensure that the fault current is commutated onto a current path in which the disconnection element 13 or 25 is connected. The fault current is then interrupted by opening the corresponding disconnection element 13 or 25.

If a fault occurs in the outgoer 8, then the adjacent commutation switching elements 11, 15, 22 are opened first of all. This results in the fault current being commutated onto a current path which contains the disconnection element 14. This disconnection element 14 is then opened, and thus interrupts the fault current. A corresponding process would be carried out in order to disconnect the fault current in the event of a fault in the outgoer 9.

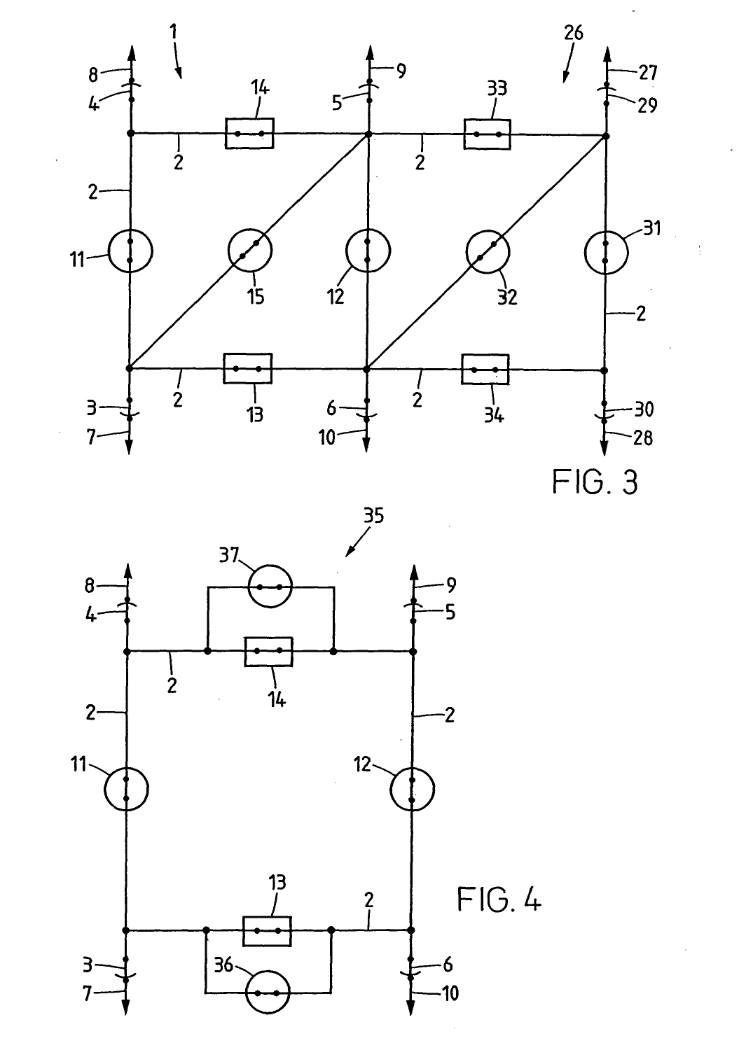

A second upgraded variant of the switchgear assembly as shown in FIG. 1 is illustrated in FIG. 3. In this second upgraded variant, the basic unit 1 as shown in FIG. 1 has an assembly block 26 added to it. The same reference symbols are used for the components of the basic unit 1 in FIGS. 1 and 3.

The assembly block 26, which is constructed in a similar manner to the assembly block 17 in the first upgraded variant, also has two outgoers 27 and 28, each of which is connected via a respective isolator 29 or 30 to the ring busbar 2. The assembly block 26 furthermore has two commutation switching elements 31, 32 and two disconnection elements 33, 34. The disconnection elements 33, 34 are arranged in the busbar 2 and connect a respective one of the outgoers 27 or 28 of the assembly block 26 to the adjacent respective outgoer 9 or 10 of the basic unit 1. The commutation switching element 31, which is likewise arranged in the busbar 2, connects the two outgoers 27 and 28 of the assembly block 26. The second commutation switching element 32 in the assembly block 26 is connected in series both with the other commutation switching element 31 in the assembly block 26 and with the commutation switching element 12 in the basic unit 1. The two series-connected commutation switching elements 31, 32 form a first parallel current path, which bridges the disconnection element 34. The other disconnection element 33 in the assembly block 26 is bridged by a second parallel current path, which is formed by the commutation switching elements 32 and 12 connected in series.

During normal operation, all the commutation switching elements 11, 12, 15, 31, 32 and all the disconnection elements 13, 14, 33, 34 in the basic unit 1 and in the assembly block 26 are closed. The commutation switching elements 11, 12, 15, 31, 32 thus carry the current and ensure that there is a connection between all the outgoers 7, 8, 9, 10, 27, 28.

If a fault occurs in one of the outgoers 7, 8, 27 or 28 then, as described with reference to FIG. 1, the opening of the corresponding adjacent commutation switching elements 11, 15, 31 and 32 ensures that the fault current is commutated onto a current path in which one of the disconnection elements 13, 14, 33 or 34 is connected. The fault current is then interrupted by opening the appropriate disconnection element 13, 14, 33 or 34.

If a fault were to occur in the outgoer 9, then the adjacent commutation switching elements 12 and 15 will be opened first of all. This will result in the fault current being commutated onto the current paths which contain the disconnection elements 14 and 33. These disconnection elements 14 and 33 would then be opened, thus interrupting the fault current. A corresponding process for disconnection of the fault current takes place in the event of a fault in the outgoer 10 (first of all, opening of the adjacent commutation switching elements 12 and 32, then opening of the disconnection elements 13 and 34).

FIG. 4 shows the basic unit 35 for a second embodiment of a switchgear assembly according to the invention. This basic unit 35 is partially constructed in the same way as the basic unit 1 shown in FIG. 1. Components which correspond to one another are therefore annotated by the same reference symbols in FIGS. 1 and 4. The basic unit 35 likewise has a ring busbar 2, four outgoers 7, 8, 9, 10 which are connected via a respective isolator 3, 4, 5 or 6 to the busbar 2, as well as two commutation switching elements 11, 12 and two disconnection elements 13, 14, which are arranged in the busbar 2 and are closed during normal operation. The commutation switching element 11 connects the outgoers 7 and 8, which are themselves connected to the outgoers 10 and 9, respectively, via the respective disconnection elements 13 and 14. The commutation switching element 12 connects the outgoers 9 and 10 to one another. Each outgoer 7, 8, 9, 10 is thus connected via a commutation switching element 11 or 12 to one of the adjacent outgoers, and is connected via a disconnection element 13 or 14 to the other of the adjacent outgoers. The basic unit 1 also has two further commutation switching elements 36 and 37. Each of these further commutation switching elements 36, 37 is connected in parallel with one of the two disconnection elements 13 or 14, respectively, and in consequence forms a parallel current path, which bridges the associated disconnection element 13 or 14.

During normal operation, all the commutation switching elements 11, 12, 36, 37 and both disconnection elements 13, 14 are closed. The commutation switching elements 11, 12, 36, 37 carry the current, and ensure that there is a connection between all the outgoers 7, 8, 9, 10. The disconnection elements 13, 14 do not carry the rated current.

If a fault occurs on the outgoer 8, then the commutation switching elements 11 and 37 which are adjacent to the fault location open first of all. The fault current is now commutated onto a current path which contains the disconnection element 14. The fault current flowing in this current path is interrupted by the disconnection element 14. The outgoers 7, 9 and 10 are still connected to one another. In the event of a fault in one of the other outgoers 7, 9 or 10, the fault current is disconnected in a corresponding manner.

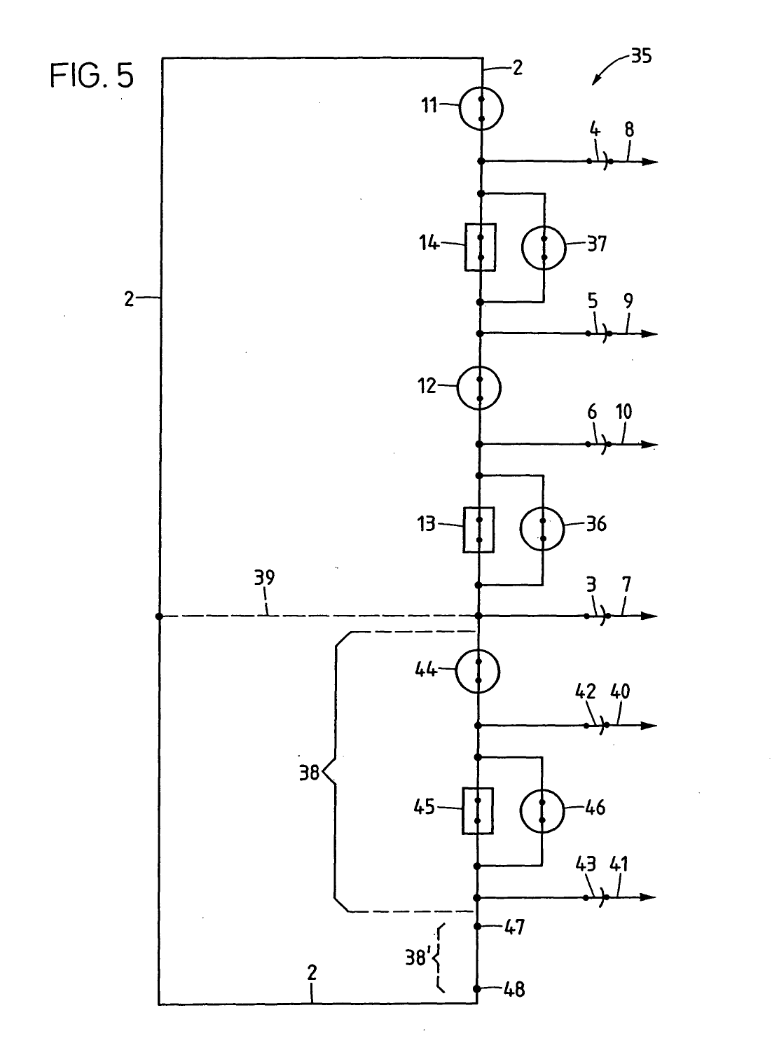

FIG. 5 shows an upgraded variant of the switchgear assembly as illustrated in FIG. 4, in which an assembly block 38 is added to the basic unit 35 as shown in FIG. 4. The same reference symbols are used for the components of the basic unit 35 in FIGS. 4 and 5. The dashed boundary line 39 is intended to indicate the boundary between the basic unit 35 and the assembly block 38.

The assembly block 38 has two outgoers 40 and 41, which are connected via a respective isolator 42 or 43 to the ring busbar 2. The assembly block 38 furthermore has a commutation switching element 44 and a disconnection element 45. The commutation switching element 44 is arranged in the busbar 2, and connects the outgoer 40 from the assembly block 38 to the adjacent outgoer 7 from the basic unit 35. The disconnection element 45, which is likewise arranged in the busbar 2, connects the two outgoers 40, 41 from the assembly block 38. The outgoer 41 is connected via the busbar 2 to the commutation switching element 11 in the basic unit 35. The assembly block 38 also has a further commutation switching element 46, which is connected in parallel with the disconnection element 45 and forms a parallel circuit, which bridges the disconnection element 45.

During normal operation, all the commutation switching elements 11, 12, 36, 37, 44, 46 and all the disconnection elements 13, 14, 45 in the basic unit 35 and in the assembly block 38 are closed. The commutation switching elements 11, 12, 36, 37, 44, 46 carry the current and ensure that there is a connection between all the outgoers 7, 8, 9, 10, 40, 41. The disconnection elements 13, 14, 45 do not carry the rated current.

In the event of a fault in one of the outgoers 7, 8, 9, 10, 40, 41, those commutation switching elements which are adjacent to the fault location are opened first of all, in the same manner as that described with reference to FIG. 4, via which the faulty outgoer is connected to the two adjacent outgoers, that is to say, for example the commutation switching elements 44 and 46 in the event of a fault in the outgoer 40. The fault current now flows via that disconnection element which connects the faulty outgoer to an adjacent outgoer, that is to say in our example via the disconnection element 45. The fault current is thus interrupted. Those outgoers which are not affected by a fault, that is to say in our examp le the outgoers 7, 8, 9, 10 and 41, are still connected to one another.

The switchgear assembly which is shown in FIG. 5 may have further assembly blocks added to it, which are constructed in the same way as the assembly block 38. One such further assembly block is indicated by 38′, and can be installed in the ring busbar 2 between the connection points 47 and 48.

Both in the switchgear assembly which has just one basic unit 35 as shown in FIG. 4, and in the upgraded switchgear assembly as shown in FIG. 5, a fault in one outgoer results in the commutation switching elements which are adjacent to this outgoer opening, so that the fault area is now connected to the rest of the switchgear assembly only via one adjacent disconnection element. This disconnection element is then opened in order to interrupt the fault current.

As described, in the event of a fault in the switchgear assemblies shown in FIGS. 4 and 5, that commutation switching element which is connected in parallel with a disconnection element is always opened first of all, with this disconnection element being opened only subsequently. This allows a common drive to be used for a disconnection element and the associated commutation switching element. The unit which comprises a disconnection element and a commutation switching element connected in parallel may be formed by a conventional circuit breaker. This makes it possible to add additional outgoers to an existing switchgear assembly with a ring busbar, by installing additional commutation switching elements between each two circuit breakers. This allows up to twice as many outgoers to be connected.

There must be an even number of outgoers, but at least four of them, in all the switchgear assemblies according to the invention.

List of Reference Symbols

1 Basic unit
2 Ring busbar
3, 4, 5, 6 Isolator
7, 8, 9, 10 Outgoer
11, 12 Commutation switching element
13, 14 Disconnection element
15 Commutation switching element
16 Power switching device
17 Assembly block
18, 19 Outgoer
20, 21 Isolator
22, 23, 24 Commutation switching element
25 Disconnection element
26 Assembly block
27, 28 Outgoer
29, 30 Isolator
31, 32 Commutation switching element
33, 34 Disconnection element
35 Basic unit
36, 37 Commutation switching element
38, 38′ Assembly block
39 Boundary line
40, 41 Outgoer
42, 43 Isolator
44 Commutation switching element
45 Disconnection element
46 Commutation switching element
47, 48 Connection point

1. A switchgear assembly for distribution of electrical power having a ring busbar, having a number of outgoers which can be connected to the busbar via isolators and having switching elements which are arranged between each two outgoers in the busbar and are closed during normal operation, wherein a basic unit, which has four outgoers in which two commutation switching elements (which are closed during normal operation and are designed for carrying the rated current and, briefly, a fault current, but are not designed for disconnection of fault currents) and two disconnection elements (which are closed during normal operation and are designed for fault current interruption, but not for carrying the rated current) are arranged in the busbar in such a way that each outgoer is connected to the one, first of the adjacent outgoers via a commutation switching element, and is connected to the other, second of the adjacent outgoers via a disconnection element, and in which each disconnection element is bridged by a parallel current path, which has a third commutation switching element, which is closed during normal operation, and is likewise designed for carrying the rated current and, briefly, a fault current, but is not designed for disconnection of fault currents.

2. The switchgear assembly as claimed in claim 1, wherein a third commutation switching element is provided, which is shared by the two parallel current paths and is connected in series both with the one and with the other of the two commutation switching elements which are arranged in the busbar and which, together with each of these commutation switching elements, forms one of the parallel current paths.

3. The switchgear assembly as claimed in claim 1, wherein the third commutation switching element is connected in parallel with the associated disconnection element in each parallel current path.

4. The switchgear assembly as claimed in claim 2, wherein the basic unit has at least one assembly block added to it, which has two further outgoers which can be connected to the busbar via isolators, two further commutation switching elements which are arranged in the busbar and each connect one of the further outgoers to an adjacent outgoer of the basic unit, a further disconnection element which is arranged between the two further outgoers in the busbar, and a third further commutation switching element which is connected in series both with the one and with the other of the two further commutation switching elements, and, together with one of these two further commutation switching elements, forms a parallel current path which bridges the further disconnection element.

5. The switchgear assembly as claimed in claim 2, wherein the basic unit has at least one assembly block added to it, which has two further outgoers which can be connected to the busbar via isolators, two further disconnection elements which are arranged in the busbar and each connect one of the further outgoers to an adjacent outgoer of the basic unit, a first further commutation switching element which is arranged between the two further outgoers in the busbar, and a second further commutation switching element which is connected in series both with the first further commutation switching element and with one commutation switching element of the basic unit, and, together with each of these commutation switching elements, in each case forms a parallel current path which bridges one of the further disconnection elements.

6. The switchgear assembly as claimed in claim 3, wherein the basic unit has at least one assembly block added to it, which has two further outgoers which can be connected to the busbar via isolators and of which a first outgoer is connected to a commutation switching element (which is arranged in the busbar) of the basic unit, a first further commutation switching element which is arranged in the busbar and connects the other, second of the further outgoers to an adjacent outgoer of the basic unit, a further disconnection element which is arranged between the two further outgoers in the busbar, and a parallel current path which bridges the further disconnection element and has a second further commutation switching element which is connected in parallel with the further disconnection element.

7. The switchgear assembly as claimed in claim 3, wherein the unit comprising a disconnection element and a parallel-connected commutation switching element is formed by a circuit breaker.

8. The switchgear assembly as claimed in claim 3, wherein a common drive is provided for a disconnection element and for the commutation switching element which is connected in parallel with it.

9. A method for operating the switchgear assembly as claimed in claim 1, wherein, in the event of a fault in one outgoer, the commutation switching elements which are adjacent to the fault location are opened first, which results in the current being commutated onto a current path in which a disconnection element which is adjacent to the fault location is connected, and in that the disconnection element in this current path is then opened.
